(19) United States
(12) Patent Application Publication
(10) Pub. No.: US 2019/0354886 A1
(43) Pub. Date: Nov. 21, 2019

(54) METHODS AND APPARATUSES FOR SEGMENTING TEXT

(71) Applicant: CANON KABUSHIKI KAISHA, Tokyo (JP)

(72) Inventors: Yaohai Huang, Beijing (CN); Qinan Hu, Beijing (CN); Ruishan Guo, Beijing (CN)

(21) Appl. No.: 16/088,403

(22) PCT Filed: Mar. 22, 2017
(86) PCT No.: PCT/JP2017/011331

§ 371 Date: Sep. 25, 2018

(30) Foreign Application Priority Data
Mar. 25, 2016 (CN) 201610177984.X

(51) Int. Cl. G06N 5/04; G06F 17/27; G06N 20/00

(52) U.S. Cl. CPC G06N 5/045; G06N 20/00; G06F 17/278

(57) ABSTRACT

This invention provides methods and apparatuses for segmenting text. A method for segmenting a text including a plurality of sentences comprises: extracting a plurality of evidences and a plurality of inferences from the text; for each of said inferences, determining a preferred position for each of said evidences based on the text and/or segmentation histories, wherein the preferred position represents the position that the evidence is the most likely to take in a sequence of evidences which are used to make the inference; and segmenting the text into a plurality of sections by determining one or more of boundaries between every two consecutive sentences in the text as section boundaries based on the preferred positions for the evidences. By virtue of the present invention, the segmentation will be more accurate.

### TECHNICAL FIELD

The present invention relates to methods and apparatuses for segmenting text, and in particular, to methods and apparatuses for segmenting the text into a plurality of sections according to topics.

### BACKGROUND ART

In the prior art, several approaches for segmenting a text into multiple sections have been proposed. For example, PTL 1 discloses a method of determining whether a public sentiment topic meets an alarming condition, which comprises segmenting a text using lexical features, e.g. concepts.

However, there exist some disadvantages in those prior art technologies, such as low accuracy, or the like. The reason of the low accuracy may be that, mappings between the segmented text sections and concepts are sometimes inconsistent. For example, in the case of segmenting a medical imaging report (such as a radiology report), the physician often writes more than one diagnoses for one body part in the report. When body parts are used as the concepts to segment the medical imaging report, multiple consecutive diagnoses for one body part will be segmented into a same section, and cannot be distinguished from each other. That is to say, in the segmentation, the boundaries between the consecutive diagnoses for one body part will be missed.

FIG. 1 shows a CT image diagnosis report as an example of the medical imaging report, FIG. 2 shows a desired result of the segmentation for the text of the medical imaging report shown in FIG. 1, and FIG. 3 shows the segmentation result for the text of the medical imaging report shown in FIG. 1, which is obtained by using the prior art method.

In this example, the text to be segmented is the “Findings” part of the report. It is desired to segment the text into a plurality of sections each of which corresponds to one of the disorders listed in the “Diagnosis” part of the report, and thus each of the written disorders can be easily associated with its corresponding findings (i.e., the found abnormalities). Thus, the desired result of the segmentation includes 5 sections, as shown in FIG. 2. However, as shown in FIG. 3, the prior art method identifies 4 sections only. This is because, in the report, two of the disorders, i.e., “lung cancer” and “pulmonary emphysema” both relate to the body part “lung”, and according to the prior art method, all the sentences in the “Findings” part associated with the body part “lung” will be segmented into a same section. That is to say, the segmentation boundary between the sentences corresponding to “lung cancer” and the sentences corresponding to “pulmonary emphysema” will be missed.

In the medical imaging report field, the physician often writes more than one diagnoses for one body part in the report. Of course, the same problem exists in other similar kinds of text fields than the medical imaging report field. Therefore, there is a need for a new text segmentation technology in order to solve the above problem.

### CITATION LIST

### Patent Literature

PTL 1: US application publication US20140052753 A1 (METHOD, DEVICE AND SYSTEM FOR PROCESSING PUBLIC OPINION TOPICS)

### SUMMARY OF INVENTION

After deep research, the inventors of the present invention have found that, the writers who write medical imaging reports or similar reports have specific preferences or conventions of ordering findings or evidences when making inferences. Taking medical imaging reports as an example, the following Table 1 lists several rules of ordering and examples thereof. Generally, radiologists prefer to write significant findings in the front of insignificant ones; general findings in the front of details; and positive findings in the front of negative ones. In addition, some findings are necessary to diagnose a disease, while others are optional. Radiologists usually write necessary findings in the front of optional ones.

TABLE 1

| ID | Rules of ordering findings | Examples |
|---|---|---|
| 1 | significant -> | nodule -> hypertrophy |
| | insignificant | |
| 2 | general -> detailed | nodule -> daughter nodule |
| 3 | positive -> negative | lymphadenopathy(+) -> |
| | | pleural effusion(−) |
| 4 | necessary -> optional | nodule -> lymphadenopathy |

Therefore, the sequence of sentences (each sentence contains an evidence) in one section of the text generally conforms to a specific rule, which may be obtained by experiences or by analyzing the segmentation histories. That is to say, some kinds of sentences are always located near or at the head of the section, i.e., the start of the section, and some other kinds of sentences are mostly located near or at the tail of the section, i.e., the ending of the section. In addition, some kinds of sentences may mostly be located near or at the middle of the section. By estimating the most probable position of each sentence in the section according to the specific rule, the boundaries between different sections can be easily determined. Thus, the present inventors propose to a new segmentation method, which determines a preferred position (i.e., a most probable position) of each evidence (corresponding to each sentence) in a section for an inference based on the text and/or segmentation histories, and then segments the text into a plurality of sections based on the preferred positions for the evidences.

In other words, one concept of the present invention is that, in a medical report, starting sentences and ending sentences of a sequence of sentences used for describing one medical phenomenon (for example, a complete diagnosis) always contain some characteristic medical terms (such as, abnormality, disorder), and thus, the present invention can determine the boundary between the medical phenomenonna by determining positions (such as, head, tail) of these characteristic medical terms in the sequence of sentences. Of course, it is readily understood by those skilled in the art that, this concept of the present invention is not limited to the medical report, and can also be applied to other similar report with the medical report.

One aspect of the present invention provides a method for segmenting a text including a plurality of sentences, comprising: an extracting step of extracting a plurality of evidences and a plurality of inferences from the text; a determining step of, for each of said inferences, determining a preferred position for each of said evidences based on the text and/or segmentation histories, wherein the preferred position represents the position that the evidence is the most likely to take in a sequence of evidences which are used to make the inference; and a segmenting step of segmenting the text into a plurality of sections by determining one or more of boundaries between every two consecutive sentences in the text as section boundaries based on the preferred positions for the evidences.

By virtue of the text segmentation method and apparatus according to the present invention, the segmentation will be more accurate, and make it easier to analyze and compare speciality reports and thus save users' time. The text segmentation technology according to the present invention is especially useful for medical imaging reports, which typically make several diagnoses in one report, such as radiology reports, magnetic resonance imaging reports, medical ultrasonography or ultrasound reports, nuclear medicine reports, elastography reports, tactile imaging reports, photoacoustic imaging reports, thermography reports, and the like.

Further characteristic features and advantages of the present invention will be apparent from the following description with reference to the drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 shows a CT image diagnosis report as an example of the medical imaging report.

FIG. 2 shows a desired result of the segmentation for the text of the medical imaging report shown in FIG. 1.

FIG. 3 shows the segmentation result for the text of the medical imaging report shown in FIG. 1, which is obtained by using the prior art method.

FIG. 4 is a flowchart illustrating a method for segmenting a text including a plurality of sentences according to a first embodiment of the present invention.

FIG. 5 is a block diagram illustrating a text segmentation apparatus for segmenting a text including a plurality of sentences according to the first embodiment of the present invention.

FIG. 6 is a block diagram illustrating another text segmentation apparatus for segmenting a text including a plurality of sentences according to the first embodiment of the present invention.

FIG. 7 shows a first specific example for the text segmentation method of the first embodiment, and its extracted evidences and inferences.

FIG. 8 shows the preferred positions in the first example, determined based on the segmentation histories.

FIG. 9 shows the segmentation result for the first specific example.

FIG. 10 shows process and result of a second specific example for the text segmentation method of the first embodiment.

FIG. 11 illustrates a general hardware environment wherein each of the embodiments disclosed herein is applicable in accordance with an exemplary embodiment of the present invention.

FIG. 12 is a flowchart illustrating a method for displaying a text according to a second embodiment of the present invention.

FIG. 13 shows an exemplary displaying result for the method according to the second embodiment of the present invention.

FIG. 14 is a block diagram illustrating an apparatus for displaying a text, according to the second embodiment of the present invention.

FIG. 15 is a flowchart illustrating a method for linking texts according to a third embodiment of the present invention.

FIG. 16 is a block diagram illustrating an apparatus for linking texts according to the third embodiment of the present invention.

FIG. 17 is a flowchart illustrating a method for extracting diagnosis objects according to a fourth embodiment of the present invention, wherein the diagnosis object is a set of entities related to a diagnosis.

FIG. 18 is a block diagram illustrating an apparatus for extracting diagnosis objects according to the fourth embodiment of the present invention.

FIG. 19 is a flowchart illustrating a method for suggesting evidences for a given inference according to a fifth embodiment of the present invention.

FIG. 20 is a block diagram illustrating an apparatus for suggesting evidences for a given inference according to the fifth embodiment of the present invention.

### DESCRIPTION OF EMBODIMENTS

Embodiments of the present invention will be described in detail below with reference to the drawings.

Please note that similar reference numerals and letters refer to similar items in the figures, and thus once an item is defined in one figure, it need not be discussed for following figures.

First of all, meanings of some terms in context of the present disclosure will be explained.

The text to be segmented in the present invention generally contains a plurality of sentences which describe a plurality of evidences or findings and make more than one inferences based on these evidences. In such kind of text, the ordering of the sentences in a section of the text generally conforms to a specific rule, which may be obtained by analyzing segmentation histories or by experiences. Thus, by determining a preferred position for each of the evidences based on the text and/or segmentation histories, section boundaries can be easily determined. The preferred position represents the position that the evidence is the most likely to take in a sequence of evidences which are used to make the inference.

The text may be text of medical imaging reports, such as radiology reports, magnetic resonance imaging reports, medical ultrasonography or ultrasound reports, nuclear medicine reports, elastography reports, tactile imaging reports, photoacoustic imaging reports, thermography reports, and the like. Of course, it is readily understood by those skilled in the art that, the text to be segmented in the present invention is not limited to the medical imaging report, but can be of any kinds, as long as it contains a plurality of evidences and a plurality of inferences. The examples of such text comprise: a clinical report, preoperative and postoperative reports, an admission record, a discharge summary, or the like.

### First Embodiment

FIG. 4 is a flowchart illustrating a method for segmenting a text including a plurality of sentences according to a first embodiment of the present invention.

As shown in FIG. 4, in an extracting step 410, a plurality of evidences and a plurality of inferences are extracted from the text.

In some examples, the evidences and the inferences may be entities or named entities.

In one implementation, the extracting step 410 may comprise: identifying the evidences and/or the inferences from the text according to a pre-defined vocabulary. The above identifying operation can be realized by any kinds of appropriate methods known in the art. For example, the vocabulary may be pre-defined by users or experiments, based on the content discussed in the text. The vocabulary may comprise all or common entities for the evidences and/or inferences which will be presented in such kind of text. The evidences and/or the inferences may be identified from the text by, for example, searching and matching entities of the vocabulary with the text.

Alternatively, the extracting step 410 may comprise: extracting, from the text, entities as the evidences and/or the inferences by using an entity recognition technique. The above extracting operation can be achieved by any kinds of appropriate methods known in the art, for example, by any known Named Entity Recognition (NER) method.

In other examples, the evidences and/or the inferences may be facts, which are composed of entities and relations among them. Accordingly, in another implementation, the extracting step 410 may comprise: extracting, from the text, facts which are composed of entities and relations among them, as the evidences and/or the inferences, by using an entity recognition technique and a relation extraction technique. The above extracting operation can be achieved by any kinds of appropriate methods known in the art, for example, by any known Named Entity Recognition (NER) method and any known relation extraction method in the art.

In some cases, properties of the evidences may also be identified from the text. For example, the property of the evidence may be the polarity of the evidence, i.e., “negative” or “positive”. A “negative” evidence means that, its corresponding sentence in the text is a negative sentence expressing the evidence is not found, or explicitly recites the evidence is not significant. For example, as to the sentence “Pleural effusion is not seen”, its extracted evidence “pleural effusion” is a “negative” evidence. In contrast, a “positive” evidence means that, its corresponding sentence in the text is an affirmative sentence expressing the evidence is found, or explicitly recites the evidence is significant. For example, as to the sentence “In the peripheral of the right lung S4, nodules with diameter of 2.5 cm are observed”, its extracted evidence “nodules” is a “positive” evidence. The polarity of evidence may be identified by, for example, determining whether its corresponding sentence is an affirmative sentence or a negative sentence.

Next, in a determining step 420, for each of said inferences, a preferred position for each of said evidences is determined based on the text and/or segmentation histories, wherein the preferred position represents the position that the evidence is the most likely to take in a sequence of evidences which are used to make the inference.

In one implementation, the determining step 420 may comprise, for each of said inferences, determining a categorical value or a numerical value of the preferred position for each of said evidences based on a property of the evidence in the text and/or the segmentation histories.

In some cases, all positions in the sequence of evidences which are used to make the inference can be classified into multiple categories, such as “head position”, “middle position”, “tail position” or the like. One categorical value (such as, ‘tail’, ‘middle’, ‘head’, etc.) then may be assigned to each category. Thus, the preferred position may be represented by the categorical value.

For example, the categorical value of the preferred position may comprise at least ‘tail’ and ‘head’, and may be determined according to the polarity (positive or negative) of the evidence. The preferred position of the evidence may be determined as ‘tail’ in the case that its polarity is negative, and the preferred position of the evidence may be determined as ‘head’ in the case that the polarity of the evidence is positive.

Alternatively, the categorical value of the preferred position may be determined by: computing probabilities that the evidence is of every category corresponding to respective categorical values, and then selecting one of the categorical values as the preferred position of the evidence based on the computed probabilities. In some examples, in a simply way, the categorical value associated with the highest probability may be selected as the preferred position. The probabilities may be computed based on the property of the evidence in the text and/or the segmentation histories.

In some other cases, the preferred position can be represented by a numerical value. The numerical value of the preferred position may be determined by: computing and normalizing a position of the evidence in a sequence of evidences which are used to make the inference in each of the segmentation histories; and averaging the positions of the evidence in all of the segmentation histories, as the numerical value of the preferred position of the evidence.

For example, the step of computing and normalizing a position of the evidence may comprise: computing a distance of the evidence to a tail position in the sequence of evidences which are used to make the inference in each of the segmentation histories and normalizing the distance to the numerical range from 0 to 1, as the position of the evidence. In one example, in each segmentation history, when the evidence is just at the tail of the segmented section related to the inference, the distance of the evidence is 0, and when the evidence is just at the head of this section, the distance of the evidence is 1. The distance between the position of the evidence and the tail position may be computed and normalized by any known distance calculation method in the art and would not be particularly limited.

Next, as shown in FIG. 4, in a segmenting step 430, the text is segmented into a plurality of sections by determining one or more of boundaries between every two consecutive sentences in the text as section boundaries based on the preferred positions for the evidences.

In one implementation, before determining the section boundaries, a candidate section boundary which does not satisfy constraints imposed by the inferences may be filtered off. For example, in the case that an inference must be made by using three sequential specific evidences (for example, some diagnosis must be determined by three consecutive special steps), the boundaries between two of these sequential evidences cannot be a section boundary and need to be filtered off. That is to say, in the case that the sequence of the evidences used to make the inference must be composed of two or more specific evidences, before determining the section boundaries, candidate section boundaries among the two or more specific evidences may be filtered off.

In some examples, the section boundaries may be determined based on the preferred positions by using a pre-defined rule or using a machine learning algorithm.

The rule may be pre-defined by the user or by experiments. For example, for two consecutive sentences, in the case that the preferred position of the former sentence is the tail position and the preferred position of the latter sentence is the head position, it normally means the head of the next section follows the tail of the previous section. That is to say, a section boundary exists between these two consecutive sentences.

Thus, in the case of determining the categorical value of the preferred position as described above, the segmenting step may comprise: determining the boundary between two consecutive sentences as the section boundary in the case that the former of the two consecutive sentences contains a evidence having a preferred position of ‘tail’ and the latter contains a evidence having a preferred position of ‘head’.

In other examples, in the case of determining the numerical value of the preferred position as described above, the segmenting step may comprise: determining the boundary between two consecutive sentences as the section boundary in the case that a difference between numerical values of preferred positions of evidences contained in the consecutive sentences is greater than a pre-defined threshold. In addition, if the numerical value represents the distance to the tail position, then the numerical value of the preferred position of the former sentence needs to be smaller than the numerical value of the preferred position of the latter sentence.

In another embodiment, the text may be segmented according to the preferred positions by using machine learning algorithms. For example, a machine learning algorithm assigns a score to a sentence by using the preferred positions as a feature to determine whether it starts a new segment or not; alternatively, a machine learning algorithm selects the best segmentation from a set of candidates by using the preferred positions as a feature. The machine learning algorithm may be realized by any know technology in the art, such as Sequence Labeling technology based on HMM or CRF, or the like.

In another implementation, the method according to this embodiment may further comprise: extracting body parts from the text and segmenting the text into a plurality of portions based on the body parts; and for one or more of the segmented portions, segmenting the portion into a plurality of sections by determining one or more of boundaries between every two consecutive sentences in the portion as section boundaries based on the preferred positions for the evidences.

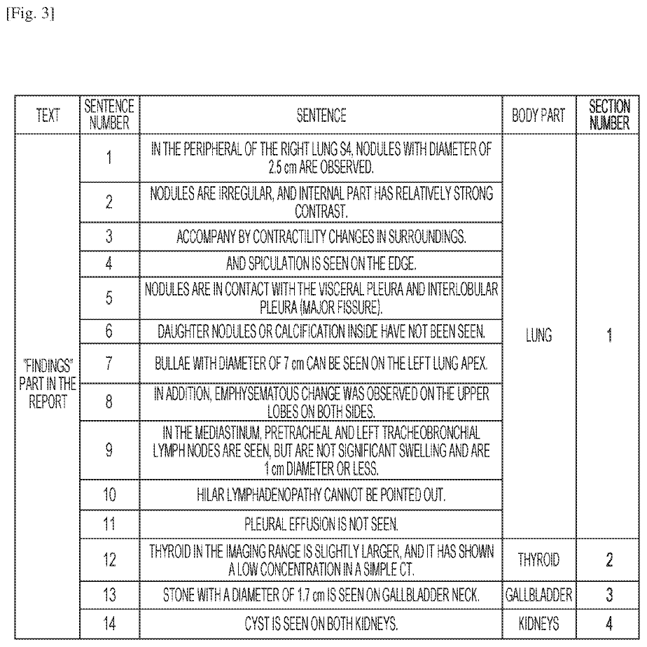

Such implementation may be a combination of the segmentation method according to the present invention with the prior art segmentation method. Firstly, by means of the prior art segmentation method, by extracting the body parts as topics, the text is segmented preliminarily into a plurality of portions based on the topics. Each portion corresponds to one body part, as shown in FIG. 3. Then, in the case that there are more than one inferences relating to a same body part, the portion corresponding to this body part is further segmented into a plurality of sections by utilizing the text segmentation method according to the present invention as described above. Such combination implementation can combine the advantages of both of the segmentation method according to the present invention and the prior art segmentation method.

In the above-described text segmentation method, the text may be a medical imaging report. In this case, the evidences correspond to abnormalities of the imaged object, and the inferences comprise disorders of the imaged object. In addition, for example, only the part recording findings (containing evidences) in the medical imaging report may be segmented.

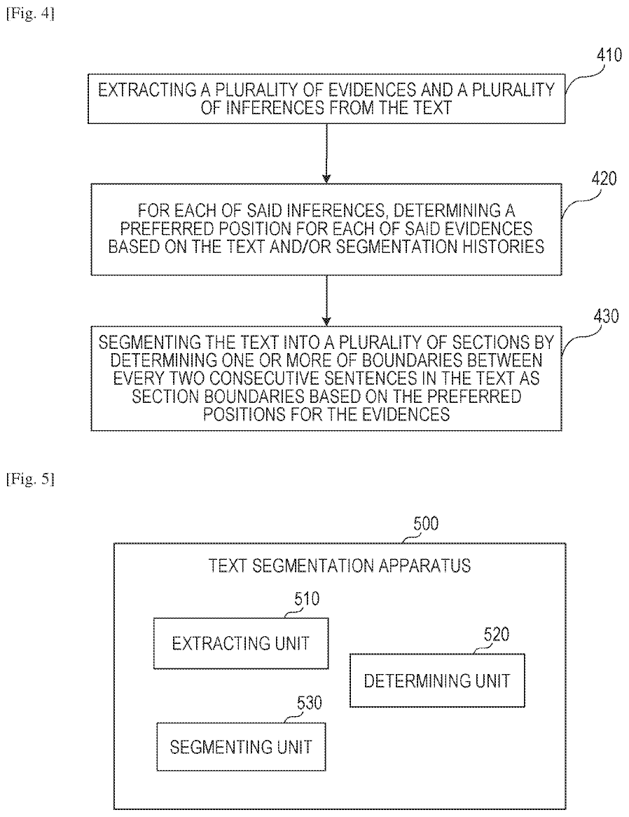

FIG. 5 is a block diagram illustrating a text segmentation apparatus 500 for segmenting a text including a plurality of sentences according to the first embodiment of the present invention.

As shown in FIG. 5, the text segmentation apparatus 500 comprises: an extracting unit 510, a determining unit 520 and a segmenting unit 530.

More specifically, the extracting unit 510 is configured for extracting a plurality of evidences and a plurality of inferences from the text.

The determining unit 520 is configured for, for each of said inferences, determining a preferred position for each of said evidences based on the text and/or segmentation histories, wherein the preferred position represents the position that the evidence is the most likely to take in a sequence of evidences which are used to make the inference.

The segmenting unit 530 is configured for segmenting the text into a plurality of sections by determining one or more of boundaries between every two consecutive sentences in the text as section boundaries based on the preferred positions for the evidences.

The respective units in the apparatus 500 can be configured to perform the respective steps shown in the flowchart in FIG. 4.

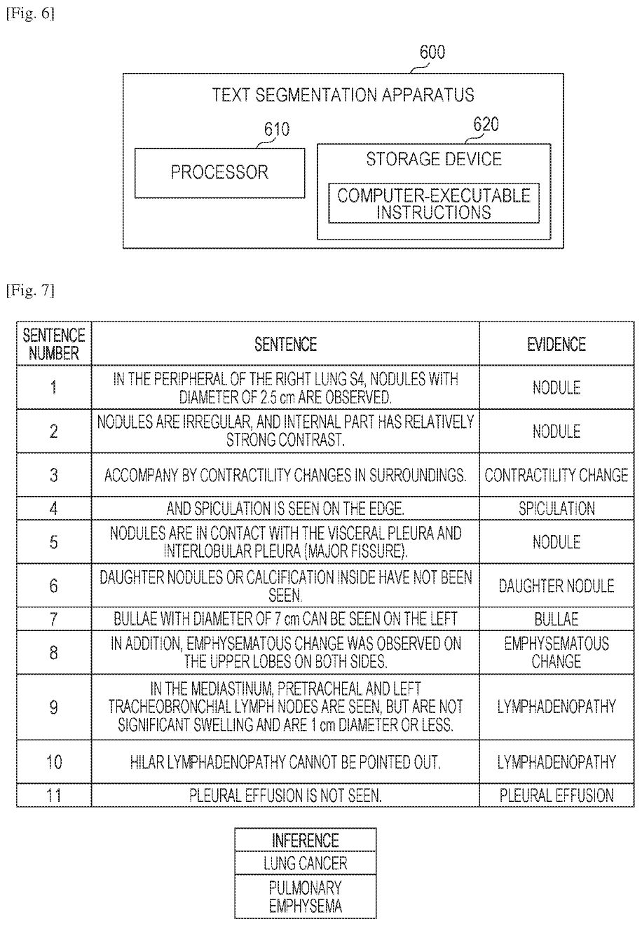

FIG. 6 is a block diagram illustrating another text segmentation apparatus 600 for segmenting a text including a plurality of sentences according to the first embodiment of the present invention.

As shown in FIG. 6, the text segmentation apparatus 600 comprises: a processor 610, and a storage device 620.

More specifically, the storage device 620 stores computer-executive instructions which can cause the processor 610 to perform the following operations:

extracting a plurality of evidences and a plurality of inferences from the text;

for each of said inferences, determining a preferred position for each of said evidences based on the text and/or segmentation histories, wherein the preferred position represents the position that the evidence is the most likely to take in a sequence of evidences which are used to make the inference; and

segmenting the text into a plurality of sections by determining one or more of boundaries between every two consecutive sentences in the text as section boundaries based on the preferred positions for the evidences.

The apparatus 600 can be adapted to perform the respective operations as described above in the text segmentation methods according to the present invention by modifying the stored computer-executive instructions.

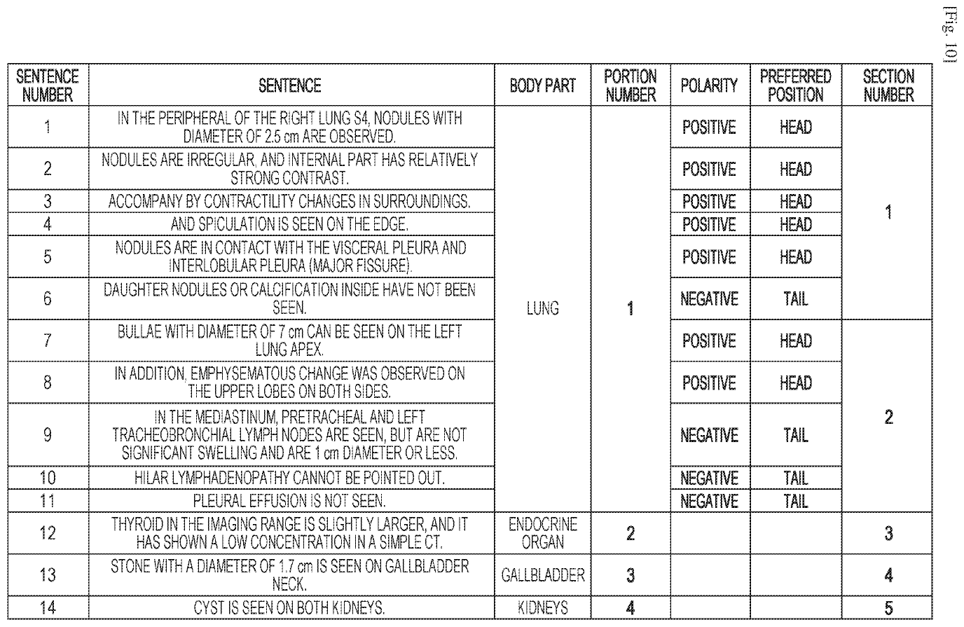

In addition, the apparatus of the first embodiment for performing the method shown in FIG. 4 can also be embodied by the hardware environment shown in FIG. 11, which will be described in details hereinafter.

With the above described text segmentation methods and apparatuses, the accuracy of the segmentation can be improved.

### First Example

Next, a first specific example of the above text segmentation method of the first embodiment will be described in details, in order for the present invention to be better and fully understood by those skilled in the art. The example is merely illustrative, but not intended to limit the present invention.

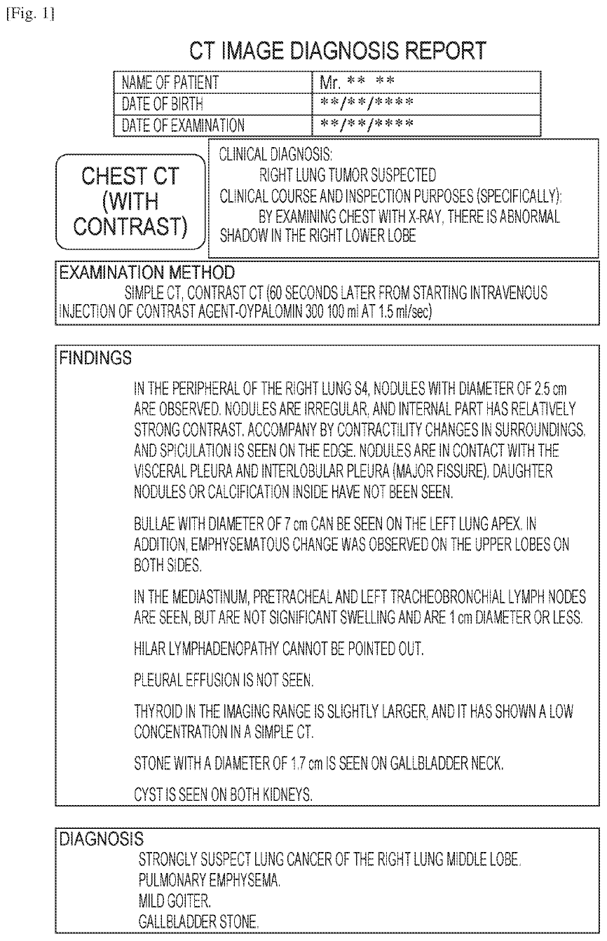

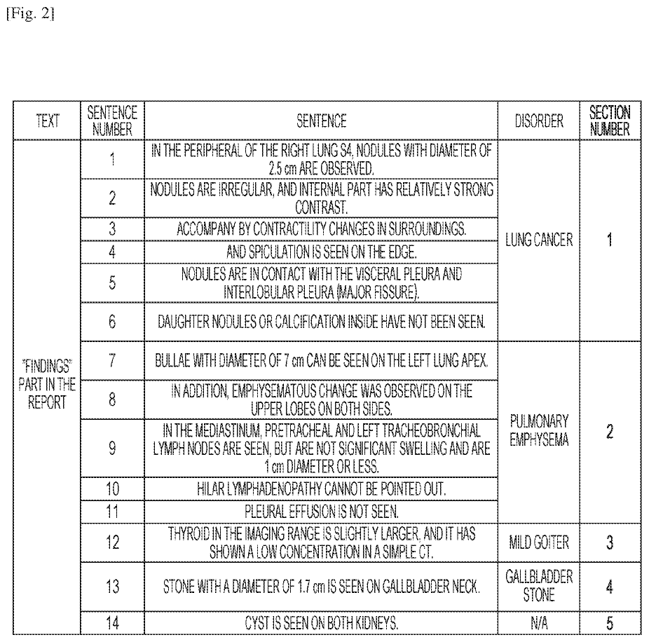

In order to better show the operation and effect of the present invention, take only a part of the medical imaging report shown in FIG. 1 as an example of the text to be segmented. The part to be segmented contains only the findings relating to the lung, i.e., the sentences No. 1 to No. 11, as shown in FIG. 7. In this case, one abnormality is extracted from each sentence, as the evidence. And disorders are extracted from the text as the inferences, as shown in FIG. 7. The abnormalities and disorders may be extracted by using a pre-defined vocabulary or by using any known entity recognition technology.

For each pair of evidence and inference, a preferred position of said evidence in the sequences of evidences which are used to make said inference may be computed statistically based on the segmentation histories.

Specifically, the sequences of abnormalities and disorders in the histories of medical imaging reports have been extracted. Those medical imaging reports have been segmented so that all abnormalities in one segment are related to one specific disorder. Furthermore, the position at which an abnormality takes when making a specific diagnosis (i.e., a disorder) is recorded.

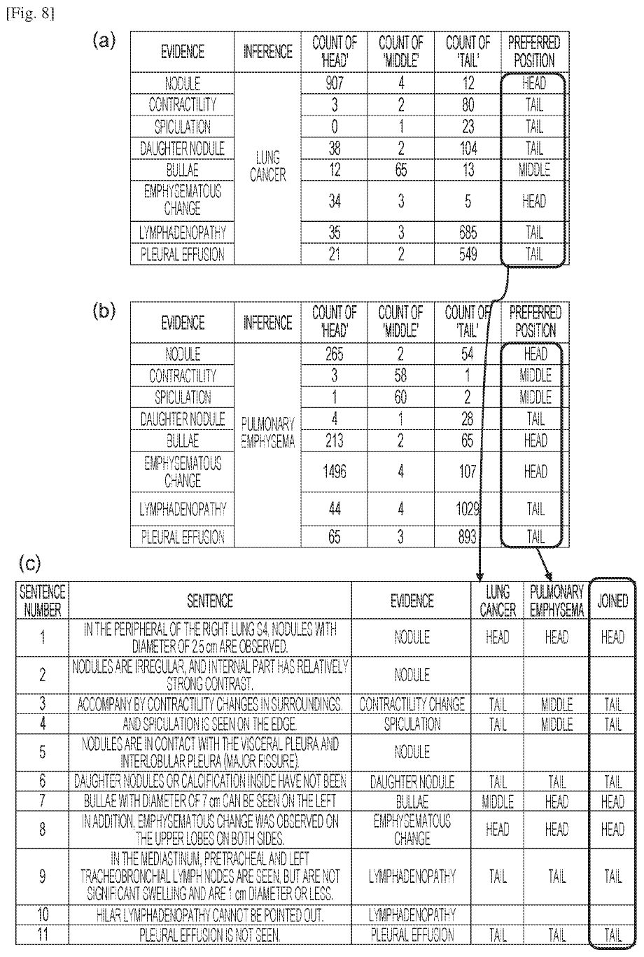

In this example, the position is a categorical value of ‘head’, ‘middle’ or ‘tail’. Then for each pair of abnormality and disorder, the number of times that the position of the abnormality is ‘head’ in the histories is counted, the number of times that the position of the abnormality is ‘middle’ in the histories is counted, and the number of times that the position of the abnormality is ‘tail’ in the histories is counted. Accordingly, the probabilities for the respective positions, i.e., ‘head’, ‘middle’ and ‘tail’, are computed. Then, the position having a probability greater than a pre-defined threshold is selected as the preferred position for this pair of abnormality and disorder, as shown in FIGS. 8(a) and 8(b).

In this example, for each abnormality, the two preferred positions for the two disorders respectively are combined to obtain the final preferred position, as shown in FIG. 8(c). The combining may be realized by averaging the two categorical values in a simple rule. Needless to say, two same positions are combined to a same position. In addition, a ‘head’ position and a ‘middle’ position are averaged as a ‘head’ position, and a ‘tail’ position and a ‘middle’ position are averaged as a ‘tail’ position.

In the case that an abnormality occurs more than once in the report, a preferred position may be assigned to the abnormality for the first time only, by using, for example, co-reference resolution technology, as disclosed in e.g. the U.S. Pat. No. 8,457,950. Therefore, some preferred positions of the evidences are absent in this example, as shown in FIG. 8(c).

Then, the part containing the eleven sentences is segmented into two sections according to their preferred positions, as shown in FIG. 9. Specifically, as described above, the part may be segmented by using a pre-defined rule. The rule is to segment text between consecutive tail and head positions in the sequence of preferred positions. That is to say, for each pair of adjacent sentences shown in FIG. 9, there is a candidate section boundary, and this candidate boundary is determined as a section boundary in the case that the former of the two consecutive sentences contains a evidence having a preferred position of ‘tail’ and the latter contains a evidence having a preferred position of ‘head’. As shown in FIG. 9, the sixth sentence and the seventh sentence satisfy the pre-defined rule, and the boundary therebetween is determined as the section boundary.

Finally, it is optional to associate the segmented sections with the inferences by any known technology in the art, as shown in the last column of FIG. 9.

### Second Example

In addition, a second specific example of the above text segmentation method of the first embodiment will be described in details next, in order for the present invention to be better and fully understood by those skilled in the art. Also, this example is merely illustrative, but not intended to limit the present invention.

In this example, the text to be segmented corresponds to the medical imaging report shown in FIG. 1. This example combines the segmentation method according to the present invention with the prior art segmentation method, as discussed above.

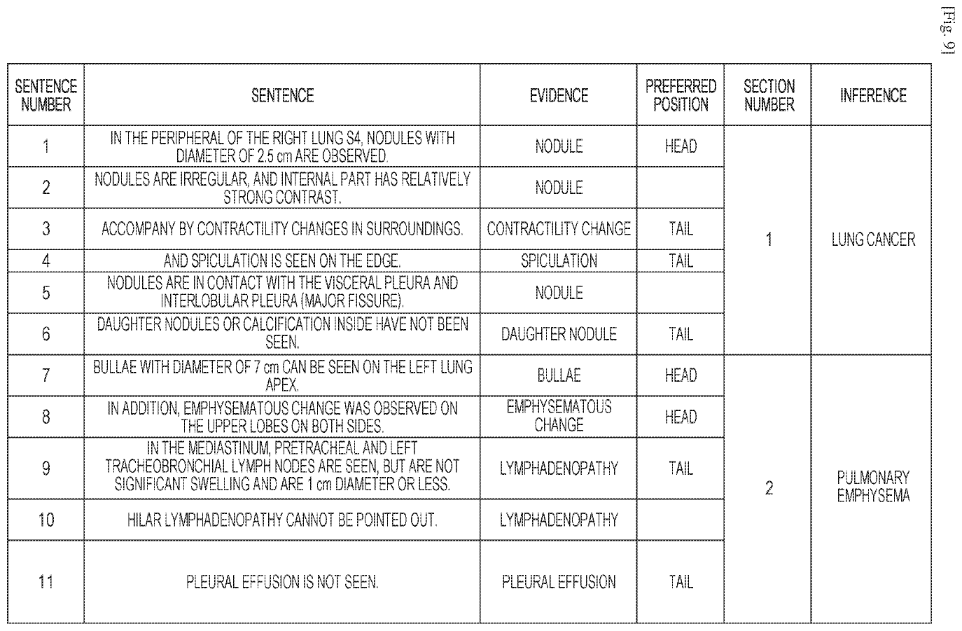

Firstly, by means of the prior art segmentation method, by extracting the body parts as topics, the text is segmented preliminarily into a plurality of portions based on the body parts. In this example, main organs are used as the body parts. Each portion corresponds to one body part, as shown in FIG. 10.

Then, note that, the second, third and fourth portions contain only one sentence respectively, and thus need not to be further segmented. But the first portion corresponding to the lung contains many sentences, which might relate to more than one inferences, and thus this portion may be further segmented into a plurality of sections by utilizing the text segmentation method according to the present invention. The first portion can be segmented into two sections by the method in the first example, as shown in FIG. 9. However, in the second example, the first portion may be segmented by an alternative method according to the first embodiment.

The polarities of the evidences, i.e., ‘negative’ and ‘positive’, may be identified from the sentences, as described above. Then, ‘head’ is assigned as preferred positions of positive evidences, and ‘tail’ is assigned as preferred positions of negative evidences, as shown in FIG. 10.

Next, the first portion may be segmented by using the preferred positions according to a pre-defined rule. The rule is to segment text between consecutive tail and head positions in the sequence of preferred positions. That is to say, for each pair of adjacent sentences shown in FIG. 10, there is a candidate section boundary therebetween, and this candidate boundary is determined as a section boundary in the case that the former of the two consecutive sentences contains a evidence having a preferred position of ‘tail’ and the latter contains a evidence having a preferred position of ‘head’. As shown in FIG. 10, the sixth sentence and the seventh sentence satisfy the pre-defined rule, and the boundary therebetween is determined as the section boundary.

The above text segmentation method according to the first embodiment can be used in many applications. Next, several major applications will be introduced below.

### Second Embodiment

The present embodiment relates to application of the text segmentation method of the first embodiment to display a text in a better way.

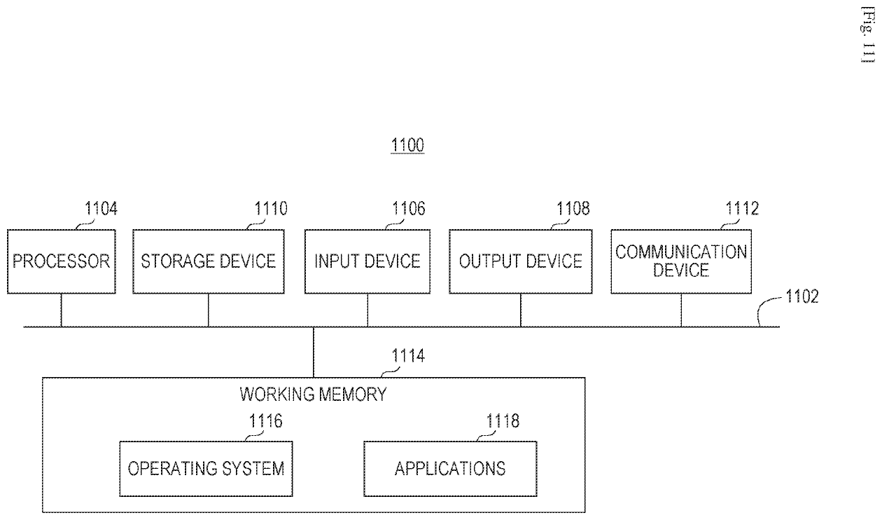

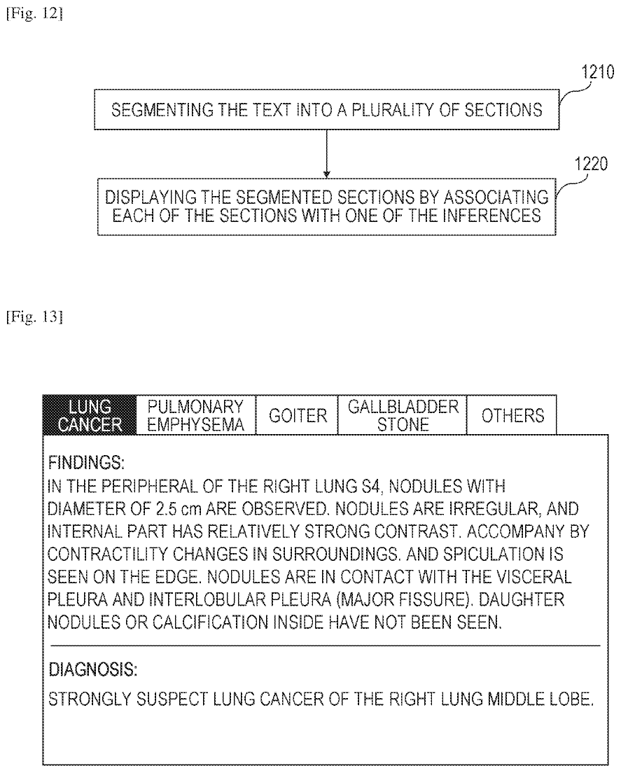

FIG. 12 is a flowchart illustrating a method for displaying a text according to a second embodiment of the present invention.

As shown in FIG. 12, firstly, in a step 1210, the text is segmented into a plurality of sections by utilizing the text segmentation method of the first embodiment.

Then, in a step 1220, the segmented sections are displayed by associating each of the sections with one of the inferences.

Take the medical imaging report shown in FIG. 1 as an example of the text to be segmented and displayed. As discussed above, this report may be segmented into five sections as shown in FIG. 10.

Then, each of the sections is associated with one of the inferences, and the text is displayed by means of multiple pages each of which has a tab describing the corresponding inference. In the page with the inference tab, the findings and diagnose in the corresponding section are displayed. However, physicians sometimes find some abnormalities but make no related diagnosis, and the fifth section has no corresponding inference. In this case, the fifth section is assigned to the last tab “others”. Finally, the report can be displayed utilizing the tabs of the inferences, and can be easily and quickly read by the users, as shown in FIG. 13.

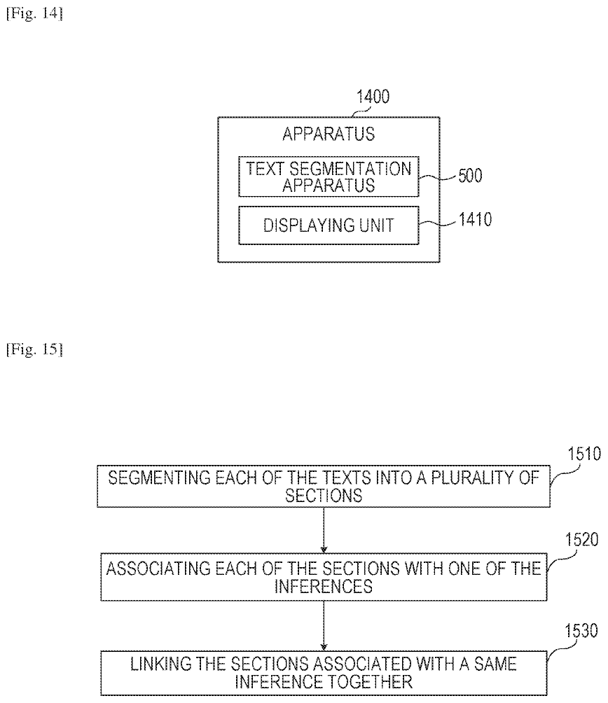

FIG. 14 is a block diagram illustrating an apparatus 1400 for displaying a text, according to the second embodiment of the present invention.

As shown in FIG. 14, the apparatus 1400 comprises: the text segmentation apparatus 500 according to the first embodiment, configured for segmenting the text into a plurality of sections; and a displaying unit 1410 configured for displaying the segmented sections by associating each of the sections with one of the inferences.

The respective units in the apparatus 1400 can be configured to perform the respective steps shown in the flowchart in FIG. 12.

### Third Embodiment

The present embodiment relates to application of the text segmentation method of the first embodiment to link texts across multiple documents.

FIG. 15 is a flowchart illustrating a method for linking texts according to a third embodiment of the present invention.

As shown in FIG. 15, firstly, in a step 1510, each of the texts is segmented into a plurality of sections by utilizing the text segmentation method of the first embodiment.

Then, in a step 1520, each of the sections is associated with one of the inferences.

Then, in a step 1530, the sections associated with a same inference are linked together. The linking operation may be realized by any known technology in the art. For example, the linking across documents may be realized based on the labels.

This embodiment links text sections of the same inferences across documents. In one example, text sections in the radiology reports of the same patient are linked together, if these sections are related to the same disorder.

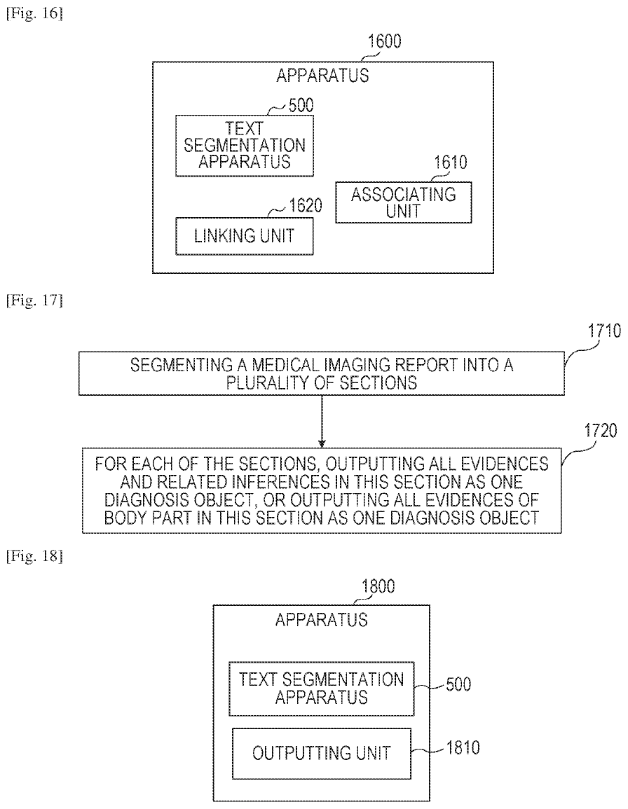

FIG. 16 is a block diagram illustrating an apparatus 1600 for linking texts according to the third embodiment of the present invention.

As shown in FIG. 16, the apparatus 1600 comprises: the text segmentation apparatus 500 according to the first embodiment, an associating unit 1610, and a linking unit 1620.

Specifically, the text segmentation apparatus 500 is configured for segmenting each of the texts into a plurality of sections.

The associating unit 1610 is configured for associating each of the sections with one of the inferences.

The linking unit 1620 is configured for linking the sections associated with a same inference together.

The respective units in the apparatus 1600 can be configured to perform the respective steps shown in the flowchart in FIG. 15.

### Fourth Embodiment

The present embodiment relates to application of the text segmentation method of the first embodiment to extract diagnosis objects.

FIG. 17 is a flowchart illustrating a method for extracting diagnosis objects according to a fourth embodiment of the present invention, wherein the diagnosis object is a set of entities related to a diagnosis.

As shown in FIG. 17, firstly, in a step 1710, a medical imaging report is segmented into a plurality of sections by utilizing the text segmentation method of the first embodiment.

Then, in a step 1720, for each of the sections, all evidences and related inferences in this section are outputted as one diagnosis object, or all evidences of body part in this section are outputted as one diagnosis object.

FIG. 18 is a block diagram illustrating an apparatus 1800 for extracting diagnosis objects according to the fourth embodiment of the present invention.

As shown in FIG. 18, the apparatus 1800 comprises: the text segmentation apparatus 500 according to the first embodiment, and an outputting unit 1810.

Specifically, the text segmentation apparatus 500 is configured for segmenting a medical imaging report into a plurality of sections.

The outputting unit 1810 is configured for, for each of the sections, outputting all evidences and related inferences in this section as one diagnosis object, or outputting all evidences of body part in this section as one diagnosis object, wherein the diagnosis object is a set of entities related to a diagnosis.

The respective units in the apparatus 1800 can be configured to perform the respective steps shown in the flowchart in FIG. 17.

### Fifth Embodiment

The present embodiment relates to application of the text segmentation method of the first embodiment to suggest evidences for a given inference.

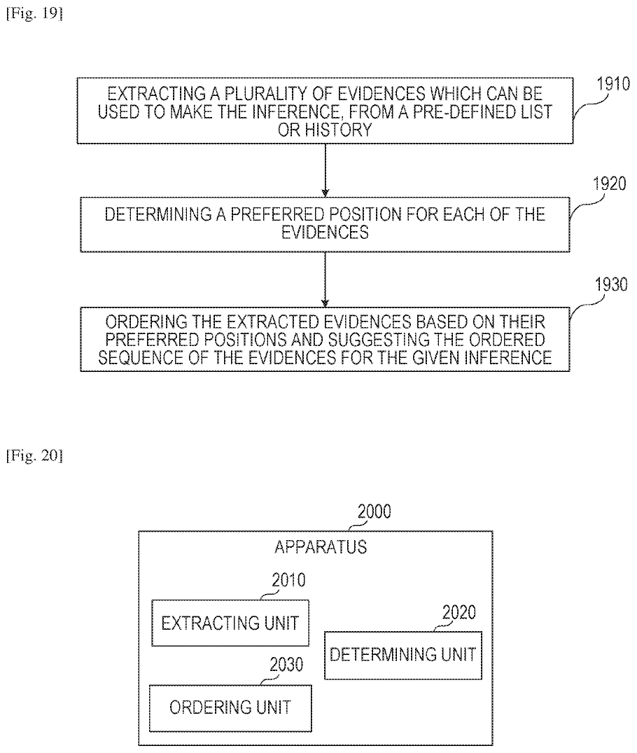

FIG. 19 is a flowchart illustrating a method for suggesting evidences for a given inference according to a fifth embodiment of the present invention.

As shown in FIG. 19, firstly, in a step 1910, a plurality of evidences which can be used to make the inference are extracted from a pre-defined list or history.

Then, in a step 1920, a preferred position for each of the evidences is determined, wherein the preferred position represents the position that the evidence is the most likely to take in a sequence of evidences which are used to make the inference. The preferred position may be determined by various ways as described above in the first embodiment, and thus the details thereof are omitted here.

Then, in a step 1930, the extracted evidences are ordered based on their preferred positions and the ordered sequence of the evidences is suggested for the given inference.

In one example, the method takes a request of examination from a clinician to a radiologist as its input. The abnormalities for the request may be identified from a pre-defined list or from history. For each abnormality, a preferred position in the sequences of abnormalities which are used to make a diagnosis for the same request is computed. Then the preferred positions are used to order the suggestions of abnormalities which are likely to be noticed by the radiologist. Then the ordered sequence of the abnormalities may be outputted as suggestions for the given inference.

FIG. 20 is a block diagram illustrating an apparatus 2000 for suggesting evidences for a given inference according to the fifth embodiment of the present invention.

As shown in FIG. 20, the apparatus 2000 comprises: an extracting unit 2010, a determining unit 2020, and an ordering unit 2030.

Specifically, the extracting unit 2010 is configured for extracting a plurality of evidences which can be used to make the inference, from a pre-defined list or history.

The determining unit 2020 is configured for determining a preferred position for each of the evidences, wherein the preferred position represents the position that the evidence is the most likely to take in a sequence of evidences which are used to make the inference.

The ordering unit 2030 is configured for ordering the extracted evidences based on their preferred positions and suggesting the ordered sequence of the evidences for the given inference.

The respective units in the apparatus 2000 can be configured to perform the respective steps shown in the flowchart in FIG. 19.

It is possible to carry out the method and apparatus of the present invention in many ways. For example, it is possible to carry out the method and apparatus of the present invention through software, hardware, firmware or any combination thereof. The above described order of the steps for the method is only intended to be illustrative, and the steps of the method of the present invention are not limited to the above specifically described order unless otherwise specifically stated. Besides, in some embodiments, the present invention may also be embodied as programs recorded in recording medium, including machine-readable instructions for implementing the method according to the present invention. Thus, the present invention also covers the recording medium which stores the program for implementing the method according to the present invention. In addition, it can be understood that various aspects/features of each of the above-described embodiments may be combined with others of above-described embodiments, unless it is explicitly stated that the combination is not allowed or the combination is not logical.

### Hardware Implementation

FIG. 11 illustrates a general hardware environment 1100 wherein each of the embodiments disclosed herein is applicable in accordance with an exemplary embodiment of the present invention.

With reference to FIG. 11, a computing device 1100, which is an example of the hardware device that may be applied to the aspects of the present invention, will now be described. The computing device 1100 may be any machine configured to perform processing and/or calculations, may be but is not limited to a work station, a server, a desktop computer, a laptop computer, a tablet computer, a personal data assistant, a smart phone, an on-vehicle computer or any combination thereof. The aforementioned apparatuses 500, 600, 1400, 1600, 1800, and 2000 each may be wholly or at least partially implemented by the computing device 1100 or a similar device or system.

The computing device 1100 may comprise elements that are connected with or in communication with a bus 1102, possibly via one or more interfaces. For example, the computing device 1100 may comprise the bus 1102, and one or more processors 1104, one or more input devices 1106 and one or more output devices 1108. The one or more processors 1104 may be any kinds of processors, and may comprise but are not limited to one or more general-purpose processors and/or one or more special-purpose processors (such as special processing chips). The input devices 1106 may be any kinds of devices that can input information to the computing device, and may comprise but are not limited to a mouse, a keyboard, a touch screen, a microphone and/or a remote control. The output devices 1108 may be any kinds of devices that can present information, and may comprise but are not limited to display, a speaker, a video/audio output terminal, a vibrator and/or a printer. The computing device 1100 may also comprise or be connected with non-transitory storage devices 1110 which may be any storage devices that are non-transitory and can implement data stores, and may comprise but are not limited to a disk drive, an optical storage device, a solid-state storage, a floppy disk, a flexible disk, hard disk, a magnetic tape or any other magnetic medium, a compact disc or any other optical medium, a ROM (Read Only Memory), a RAM (Random Access Memory), a cache memory and/or any other memory chip or cartridge, and/or any other medium from which a computer may read data, instructions and/or code. The non-transitory storage devices 1110 may be detachable from an interface. The non-transitory storage devices 1110 may have data/instructions/code for implementing the methods and steps which are described above. The computing device 1100 may also comprise a communication device 1112. The communication device 1112 may be any kinds of device or system that can enable communication with external apparatuses and/or with a network, and may comprise but are not limited to a modem, a network card, an infrared communication device, a wireless communication device and/or a chipset such as a Bluetooth™ device, 1302.11 device, WiFi device, WiMax device, cellular communication facilities and/or the like.

The bus 1102 may include but is not limited to Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computing device 1100 may also comprise a working memory 1114, which may be any kind of working memory that may store instructions and/or data useful for the working of the processor 1104, and may comprise but is not limited to a random access memory and/or a read-only memory device.

Software elements may be located in the working memory 1114, including but are not limited to an operating system 1116, one or more application programs 1118, drivers and/or other data and codes. Instructions for performing the methods and steps described in the above may be comprised in the one or more application programs 1118, and the units of the aforementioned apparatuses 500, 600, 1400, 1600, 1800, and 2000 may be implemented by the processor 1104 reading and executing the instructions of the one or more application programs 1118. More specifically, the extracting unit 510 of the aforementioned apparatus 500 may, for example, be implemented by the processor 1104 when executing an application 1118 having instructions to perform the step 410 of FIG. 4. In addition, the determining unit 520 of the aforementioned apparatus 500 may, for example, be implemented by the processor 1104 when executing an application 1118 having instructions to perform the step 420 of FIG. 4. In addition, the segmenting unit 530 of the aforementioned apparatus 500 may, for example, be implemented by the processor 1104 when executing an application 1118 having instructions to perform the step 430 of FIG. 4. Further, respective units of the aforementioned apparatuses 1400, 1600, 1800, and 2000 may also, for example, be implemented by the processor 1104 when executing an application 1118 having instructions to perform the aforementioned respective steps in FIGS. 12, 15, 17 and 19. The executable codes or source codes of the instructions of the software elements may be stored in a non-transitory computer-readable storage medium, such as the storage device(s) 1110 described above, and may be read into the working memory 1114 possibly with compilation and/or installation. The executable codes or source codes of the instructions of the software elements may also be downloaded from a remote location.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Chinese Patent Application No. 201610177984.X, filed Mar. 25, 2016, which is hereby incorporated by reference herein in its entirety.

1. A method for segmenting a text including a plurality of sentences, comprising:
an extracting step of extracting a plurality of evidences and a plurality of inferences from the text;
a determining step of, for each of said inferences, determining a preferred position for each of said evidences based on the text and/or segmentation histories, wherein the preferred position represents the position that the evidence is the most likely to take in a sequence of evidences which are used to make the inference; and
a segmenting step of segmenting the text into a plurality of sections by determining one or more of boundaries between every two consecutive sentences in the text as section boundaries based on the preferred positions for the evidences.

2. The method according to claim 1, wherein the extracting step comprises:
identifying the evidences and/or the inferences from the text according to a pre-defined vocabulary; or
extracting from the text entities as the evidences and/or the inferences by using an entity recognition technique; or
extracting from the text facts which are composed of entities and relations among them, as the evidences and/or the inferences, by using an entity recognition technique and a relation extraction technique.

3. The method according to claim 1, wherein the determining step comprises, for each of said inferences, determining a categorical value or a numerical value of the preferred position for each of said evidences based on a property of the evidence in the text and/or the segmentation histories.

4. The method according to claim 3, wherein
the categorical value of the preferred position comprises at least ‘tail’ and ‘head’, the property of the evidence comprises a polarity of the evidence, and the polarity is positive or negative, and
wherein the preferred position of the evidence is determined as ‘tail’ in the case that its polarity is negative, and the preferred position of the evidence is determined as ‘head’ in the case that the polarity of the evidence is positive.

5. The method according to claim 3, wherein determining the categorical value of the preferred position comprises: computing probabilities that the evidence is of every category corresponding to respective categorical values, and then selecting one of the categorical values as the preferred position of the evidence based on the computed probabilities.

6. The method according to claim 3, wherein determining the numerical value of the preferred position comprises:
computing and normalizing a position of the evidence in a sequence of evidences which are used to make the inference in each of the segmentation histories; and
averaging the positions of the evidence in all of the segmentation histories, as the preferred position of the evidence.

7. The method according to claim 6, wherein computing and normalizing a position of the evidence comprises:
computing a distance of the evidence to a tail position in the sequence of evidences which are used to make the inference in each of the segmentation histories and normalizing the distance to the numerical range from 0 to 1, as the position of the evidence.

8. The method according to claim 1, wherein the segmenting step comprises:
in the case that the sequence of the evidences used to make the inference must be composed of two or more specific evidences, before determining the section boundaries, filtering off candidate section boundaries among the two or more specific evidences.

9. The method according to claim 1, wherein the segmenting step comprises:
determining the section boundaries based on the preferred positions by using a pre-defined rule or using a machine learning algorithm.

10. The method according to claim 4, wherein the segmenting step comprises:
determining the boundary between two consecutive sentences as the section boundary in the case that the former of the two consecutive sentences contains a evidence having a preferred position of ‘tail’ and the latter contains a evidence having a preferred position of ‘head’.

11. The method according to claim 6, wherein the segmenting step comprises:
determining the boundary between two consecutive sentences as the section boundary in the case that a difference between numerical values of preferred positions of evidences contained in the consecutive sentences is greater than a pre-defined threshold.

12. The method according to claim 1 further comprising:
extracting body parts from the text and segmenting the text into a plurality of portions based on the body parts; and
for one or more of the segmented portions, segmenting the portion into a plurality of sections by determining one or more of boundaries between every two consecutive sentences in the portion as section boundaries based on the preferred positions for the evidences.

13. The method according to claim 1, wherein the text is a medical imaging report, the evidences correspond to abnormalities of the imaged object, and the inferences comprise disorders of the imaged object.

14. A method for displaying a text, comprising:
segmenting the text into a plurality of sections by utilizing the method according to claim 1; and
displaying the segmented sections by associating each of the sections with one of the inferences.

15. A method for linking texts, comprising:
segmenting each of the texts into a plurality of sections by utilizing the method according to claim 1;
associating each of the sections with one of the inferences; and
linking the sections associated with a same inference together.

16. A method for extracting diagnosis objects, wherein the diagnosis object is a set of entities related to a diagnosis, the method comprising:
segmenting a medical imaging report into a plurality of sections by utilizing the method according to claim 1; and
for each of the sections, outputting all evidences and related inferences in this section as one diagnosis object, or outputting all evidences of body part in this section as one diagnosis object.

17. A method for suggesting evidences for a given inference, comprising:
extracting a plurality of evidences which can be used to make the inference, from a pre-defined list or history;
determining a preferred position for each of the evidences, wherein the preferred position represents the position that the evidence is the most likely to take in a sequence of evidences which are used to make the inference; and
ordering the extracted evidences based on their preferred positions and suggesting the ordered sequence of the evidences for the given inference.

18. An apparatus for segmenting a text including a plurality of sentences, comprising:
a processor; and
a storage device having computer-executive instructions stored thereon which can cause the processor to perform:
extracting a plurality of evidences and a plurality of inferences from the text; for each of said inferences, determining a preferred position for each of said evidences based on the text and/or segmentation histories, wherein the preferred position represents the position that the evidence is the most likely to take in a sequence of evidences which are used to make the inference; and
segmenting the text into a plurality of sections by determining one or more of boundaries between every two consecutive sentences in the text as section boundaries based on the preferred positions for the evidences.

19. An apparatus for segmenting a text including a plurality of sentences, comprising:
an extracting unit, configured for extracting a plurality of evidences and a plurality of inferences from the text;
a determining unit, configured for, for each of said inferences, determining a preferred position for each of said evidences based on the text and/or segmentation histories, wherein the preferred position represents the position that the evidence is the most likely to take in a sequence of evidences which are used to make the inference; and
a segmenting unit, configured for segmenting the text into a plurality of sections by determining one or more of boundaries between every two consecutive sentences in the text as section boundaries based on the preferred positions for the evidences.

20. The apparatus according to claim 19, wherein the extracting unit comprises:
a unit configured for identifying the evidences and/or the inferences from the text according to a pre-defined vocabulary; or
a unit configured for extracting from the text entities as the evidences and/or the inferences by using an entity recognition technique; or
a unit configured for extracting from the text facts which are composed of entities and relations among them, as the evidences and/or the inferences, by using an entity recognition technique and a relation extraction technique.

21. The apparatus according to claim 19, wherein the determining unit comprises, a unit configured for, for each of said inferences, determining a categorical value or a numerical value of the preferred position for each of said evidences based on a property of the evidence in the text and/or the segmentation histories.

22. The apparatus according to claim 21, wherein
the categorical value of the preferred position comprises at least ‘tail’ and ‘head’, the property of the evidence comprises a polarity of the evidence, and the polarity is positive or negative, and
wherein the preferred position of the evidence is determined as ‘tail’ in the case that its polarity is negative, and the preferred position of the evidence is determined as ‘head’ in the case that the polarity of the evidence is positive.

23. The apparatus according to claim 21, wherein the unit configured for determining the categorical value of the preferred position comprises:
a unit configured for computing probabilities that the evidence is of every category corresponding to respective categorical values, and then selecting one of the categorical values as the preferred position of the evidence based on the computed probabilities.

24. The apparatus according to claim 21, wherein the unit configured for determining the numerical value of the preferred position comprises:
a unit configured for computing and normalizing a position of the evidence in a sequence of evidences which are used to make the inference in each of the segmentation histories; and
a unit configured for averaging the positions of the evidence in all of the segmentation histories, as the preferred position of the evidence.

25. The apparatus according to claim 24, wherein the unit configured for computing and normalizing a position of the evidence comprises:
a unit configured for computing a distance of the evidence to a tail position in the sequence of evidences which are used to make the inference in each of the segmentation histories and normalizing the distance to the numerical range from 0 to 1, as the position of the evidence.

26. The apparatus according to claim 19, wherein the segmenting unit comprises:
a unit configured for, in the case that the sequence of the evidences used to make the inference must be composed of two or more specific evidences, before determining the section boundaries, filtering off candidate section boundaries among the two or more specific evidences.

27. The apparatus according to claim 19, wherein the segmenting unit comprises:
a unit configured for determining the section boundaries based on the preferred positions by using a pre-defined rule or using a machine learning algorithm.

28. The apparatus according to claim 22, wherein the segmenting unit comprises:
a unit configured for determining the boundary between two consecutive sentences as the section boundary in the case that the former of the two consecutive sentences contains a evidence having a preferred position of ‘tail’ and the latter contains a evidence having a preferred position of ‘head’.

29. The apparatus according to claim 24, wherein the segmenting unit comprises:
a unit configured for determining the boundary between two consecutive sentences as the section boundary in the case that a difference between numerical values of preferred positions of evidences contained in the consecutive sentences is greater than a pre-defined threshold.

30. The apparatus according to claim 19 further comprising:
a unit configured for extracting body parts from the text and segmenting the text into a plurality of portions based on the body parts; and
a unit configured for, for one or more of the segmented portions, segmenting the portion into a plurality of sections by determining one or more of boundaries between every two consecutive sentences in the portion as section boundaries based on the preferred positions for the evidences.

31. The apparatus according to claim 19, wherein the text is a medical imaging report, the evidences correspond to abnormalities of the imaged object, and the inferences comprise disorders of the imaged object.

32. An apparatus for displaying a text, comprising:
the apparatus according to claim 19, configured for segmenting the text into a plurality of sections; and
a displaying unit configured for displaying the segmented sections by associating each of the sections with one of the inferences.

33. An apparatus for linking texts, comprising:
the apparatus according to claim 19, configured for segmenting each of the texts into a plurality of sections;
an associating unit configured for associating each of the sections with one of the inferences; and
a linking unit configured for linking the sections associated with a same inference together.

34. An apparatus for extracting diagnosis objects, wherein the diagnosis object is a set of entities related to a diagnosis, the apparatus comprising:
the apparatus according to claim 19, configured for segmenting a medical imaging report into a plurality of sections; and
an outputting unit configured for, for each of the sections, outputting all evidences and related inferences in this section as one diagnosis object, or outputting all evidences of body part in this section as one diagnosis object.

35. An apparatus for suggesting evidences for a given inference, comprising:
an extracting unit configured for extracting a plurality of evidences which can be used to make the inference, from a pre-defined list or history;
a determining unit configured for determining a preferred position for each of the evidences, wherein the preferred position represents the position that the evidence is the most likely to take in a sequence of evidences which are used to make the inference; and
an ordering unit configured for ordering the extracted evidences based on their preferred positions and suggesting the ordered sequence of the evidences for the given inference.
